(19) United States
(12) Patent Application Publication
(10) Pub. No.: US 2014/0323045 A1
(43) Pub. Date: Oct. 30, 2014

(54) NFC DEVICE AND CONNECTION SYSTEM OF NFC DEVICES

(71) Applicant: FAMOCO, Paris (FR)

(72) Inventors: Lionel Brahami, Gradignan (FR); Nicolas Berbigier, Saint-Gilles (BE)

(73) Assignee: FAMOCO, Paris (FR)

(21) Appl. No.: 14/358,525

(22) PCT Filed: Nov. 15, 2012
(86) PCT No.: PCT/EP2012/072784

§ 371 Date: May 15, 2014

(30) Foreign Application Priority Data
Nov. 15, 2011 (FR) 11/03456

(51) Int. Cl. H04B 5/00

(52) U.S. Cl. CPC H04B 5/0031
USPC 455/41.1

(57) ABSTRACT

The present device aggregates all kinds of contactless services such as credit card, loyalty card, micro-payment, discount card, transport card, access control, e-ticket, parking, etc. An NFC (Near Field Communication) device comprises a host CPU, a memory, a GPRS modem controlled by the CPU to access Internet, a SIM holder, an antenna and a battery. The NFC device is shaped as a credit card and it also includes a touch-screen, able to implement technical functionalities to operate contactless services, visualize his ticket/coupon and consult the latest transaction, a secure element to store and execute the contactless applications, and a ST controller connected to Host CPU and to the SE.

### CROSS-REFERENCE TO RELATED APPLICATIONS

This application is a U.S. National Phase Entry of International Application No. PCT/EP2012/072784, filed on Nov. 15, 2012, which claims priority to French Patent Application Ser. No. 11/03456, filed on Nov. 15, 2011, both of which are incorporated by reference herein.

### BACKGROUND

The invention relates to a NFC (Near Field Communication) device shaped as a credit card with a touch-screen able to implement technical functionalities and a connection system of NFC devices.

NFC technology development in the mobile communication field is growing up with the integration of contactless radio frequency identification and interconnectivity. The functions of card reader, induction card and peer-to-peer are integrated in a single chip. NFC technology involves also identification and data exchanges with compatible devices within short distance by inductive coupling of radio frequency. In particular, the NFC mobile phone allows the short distance wireless communication and achieves a plurality of functions: electronic payment, tag reading, tickets system and data download.

### SUMMARY

The problem is the aggregation of the more and more functions and their compatibility. The goal of this device is to aggregate all kind of contactless services such as credit card, loyalty card, micro-payment, discount card, transport card, access control, e-ticket, parking, etc. The NFC device according to the invention is defined with combinations of particular features of claims 1 to 10 and the connection system with the combination of particular features of claim 11.

The device is connected to mobile Internet through a GPRS connection, which let user receives e-coupon and e-ticket “over the air”, top-up (recharge) an e-wallet or extends validity of an e-transport or e-parking card without having to queue at the cashier. The touch-screen lets the user operate the service, visualize his ticket/coupon, consult the latest transaction, and so on. The NFC device has a secure element SE to store the contactless application. The Secure Element is a smartcard like a microcontroller that stores and executes application called Cardlet. Each Cardlet implements the contactless service.

Through the mobile Internet connectivity, NFC devices are connected to a backend server. The backend server is used to manage application download on the NFC device and on the secure element. Through the backend server, when a new user subscribes a service, the contactless application is downloaded to the SE and the user interface is downloaded to the NFC device of the new subscriber.

The device is powered on a rechargeable battery. But it can still operate when the battery is empty (battery off mode), Beijing powered-up by the magnetic induction field issued from the POS. In that mode, the screen and GPRS connection is not functional, but contactless transaction can still be done.

### BRIEF DESCRIPTION OF THE DRAWINGS

FIG. 1 describes the main device's functionalities of an example of a NFC device according to the invention;

FIG. 2 describes the power on/off life cycle of the NFC device example;

The layout cut of the NFC device example is illustrated in FIG. 3; and

The software stack design of the same example is showed in the FIG. 4.

### DETAILED DESCRIPTION OF THE PREFERRED EMBODIMENTS

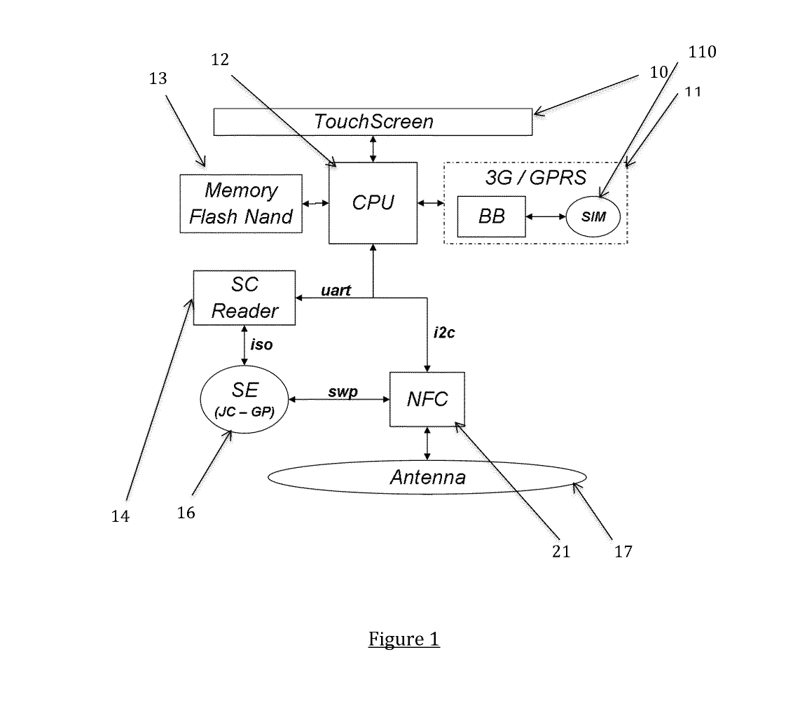

As shown in FIG. 1, an example of NFC device according to the invention is built around a CPU/MCU 12 with NAND flash memory and RAM 13. The touch-screen 10 is made of a color LCD display and an associated Touch-Panel. The device has Internet access through a GSM/GPRS modem 11. The GPRS modem is controlled with the CPU 12. GPRS Modem 11 is connected to CPU/MCU 12, and it can be powered on/off by CPU/MCU's GPIO. A SIM/miniSIM holder 110 will receive the SIM needed to GPRS/3G communication.

The NFC device is powered with NFC FrontEnd Controller 21. The NFC FrontEnd Controller 21 is connected to Host CPU/MCU 12. NFC FrontEnd Controller 21 is then connected to a Secure Element 16.

The NFC Device received NFC radio-frequency thought an Antenna 17 designed as a external board, or as a wire wrapped and embedded into the device case. A specific power management module powers up the NFC part. In order to take advantage of the battery off mode, the SE 16 power pin is connected to a pin of the NFC FrontEnd Controller 21. The NFC FrontEnd Controller 21 is connected to the battery in order to have the NFC feature available event if the device is power off.

In order to let host CPU/MCU 12 access the SE 16 directly, the device uses a dedicated chip, a SC Reader 14. The SC reader 14 is connected to the SE 16 with a standard ISO 7816 connection, and to the host CPU/MCU 12. As the SC reader 14 is a generic micro-controller, a special firmware is designed to interface the Host CPU/MCU 12.

The NFC device is powered by a battery and recharged from a USB connector. A LED indicates when the device is charging and when full charge level is reached. The hardware provides battery charge level information.

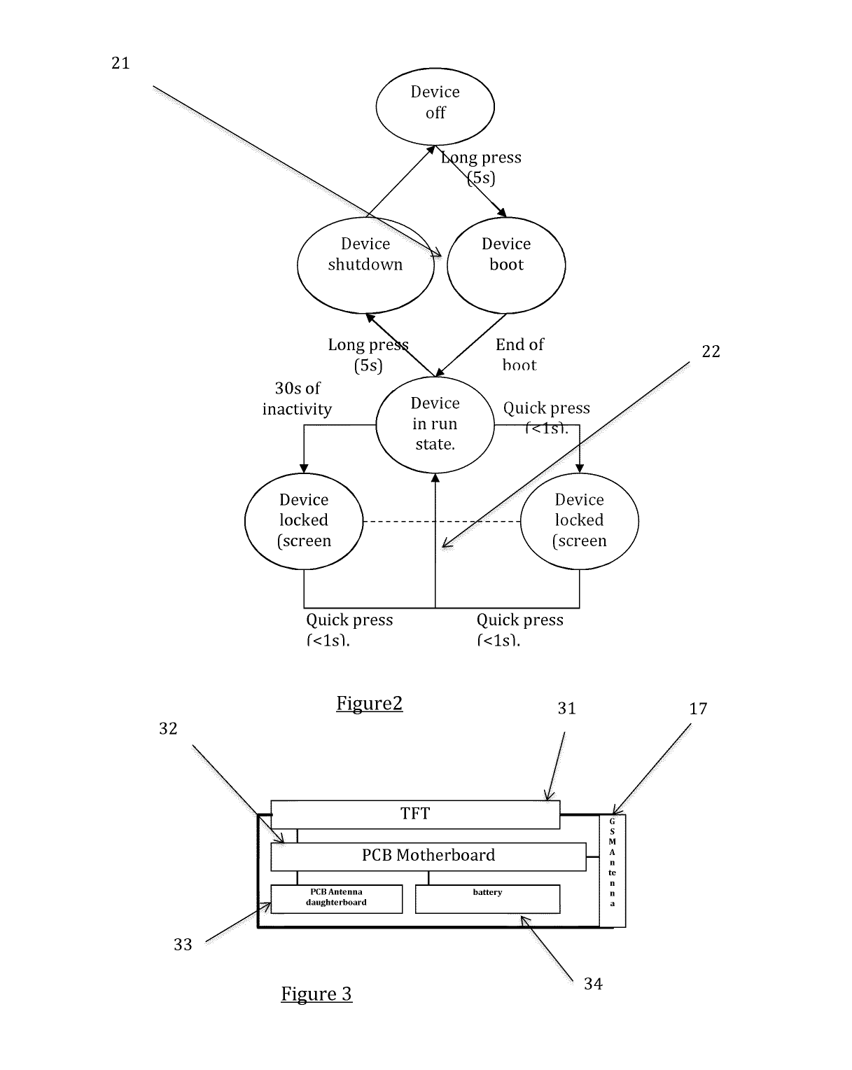

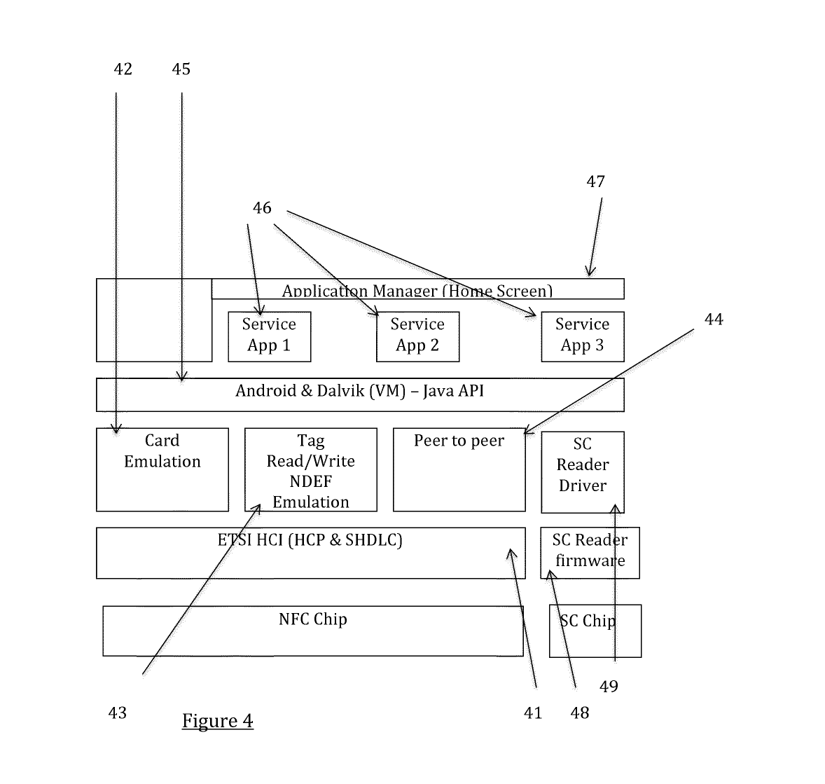

The FIG. 2 describes an example of the NFC device's power on/off life cycle. A two states button 21 located on the top (or on the side) of the device powers on/off & lock/unlock the device. The life cycle is described in FIG. 2.

The device layout cut is illustrated in FIG. 3. It comprises:

a LCD/TP layer 31, connected to

a Printed Circuit Board (PCB) motherboard 32, connected to

a NFC antenna 33 and to a battery 34, and

the GSM antenna 17 connected to the PCB motherboard 32.

The device size is credit card format (85 mm×54 mm) and fits cabling and the above mentioned chips/feature. The device is running a custom software. The high level software stack design is showed in the FIG. 4.

The NFC stack is broken into two subcomponents:

a HCl layer 41, which implements the protocol related to NFC Front-End controller.

a NFC Forum specification layer with a card emulation 42, NDEF Emulation 43 and peer-to-peer module 44. This layer implements NFC Forum specification.
This last layer provides specific Apis 45 to let service application control/access NFC feature of the NFC Front-End controller.

The application layer consists in two kinds of components:

service applications 46 that implements a given service, like e-wallet, e-coupon wallet, etc.;

Service Application Manager SAM 47 that manages Service Application running on the board.

SC Reader Firmware 48 interfaces the host CPU/MCU with the SE through an ISO7816 connection. SC Reader Driver 49 provides API to interface Application Layer with SC reader through the SC Reader Firmware 48.

Service Apps are under management of SAM-Home-Screen 47 (Service App manager). Service Apps are started or deleted through SAM 47. SAM is started at device startup and is always running in the background. User cannot close/kill/terminate SAM.

SAM Maintain a list of Service Application installed on the device and show a “cover flow” with all Service App's icons. SAM lets the user browse all Service App Icon and launch/starts the selected Service App. SAM monitors running Service App and bring itself to front end when running Service App is terminated. (SAM always remains on the background).

Service App can register to SAM for NFC Activity. Service App will give the AID of the Card application they are related to. When POS will send data to that Card Application SAM will start the associated Service App. SAM supports read/write Smart Poster feature. When user “tap” a smart poster, SAM will pop-up a dialog and performs the actions associated with the tag.

Tag associated actions are:

Trigger Service App launch;

Trigger Service App download;

Trigger Service App content download;

Download and render a predefined simple XML format to display text and image;

Send HTTP notification to the server.

1. A device (NFC) comprising a host CPU/MCU, a memory, a GPRS modem controlled by the CPU to access an Internet, a SIM holder, an antenna and a battery, the NFC being shaped as a credit card and further comprising a touch-screen adapted to operate contactless services, visualize a ticket/coupon, and consult the latest transaction or equivalent, a secure element (SE) adapted to store and execute the contactless applications, and a NFC Front-end controller connected to host CPU/MCU and to the SE.

2. The NFC device according to claim 1, wherein the antenna is on a daughterboard connected to a motherboard on which the battery is connected.

3. The NCF device according to claim 1, wherein the touch-screen is a color LCD display and the associated touch-panel.

4. The NCF device according to claim 1, wherein, in order to let Host CPU access the SE, the device uses a dedicated SC Reader as a smartcard chip, the SC reader being connected to the SE and to the host CPU.

5. The NCF device according to claim 1, wherein a specific power management module powers up the NFC device with a stabilized tension, the ST controller main power pin is connected to the power module and, in order to take advantage of the battery off mode, the SE power pin is connected to a ST pin.

6. The NCF device according to claim 1, wherein the ST controller battery pin is connected to the battery in order to have the NFC feature available event if the device is power off.

7. The NCF device according to claim 4 wherein, the SC reader being a generic micro-controller, a firmware being designed to interface the Host CPU.

8. The NCF device according to claim 1, wherein the NCF device layout comprises a TFT layer connected to a printed circuit board PCB motherboard connected to a PCB antenna daughterboard and to a battery, and the GSM antenna connected to the TFT layer and to the PCB motherboard.

9. The NFC device according to claim 1, and including a software components stack broken into two subcomponents: a HCl layer, which implements the protocol related to ST command via a driver, and a NFC Forum specification layer with a card emulation, NDEF Emulation and a peer-to-peer module.

10. The NFC device according to claim 9, wherein the NFC Forum specification layer provides applications in two kinds of components: service applications that implements a given service, and a service application Manager that manages the service application running on the board.

11. A connection system of Near Field Communication devices (NFC), the system comprising:
a host CPU/MCU, a memory, a GPRS modem controlled by the CPU to access an Internet, a SIM holder, and a battery, the NFC further comprising a touch-screen adapted to operate a contactless application, visualize a ticket/coupon, and consult the latest transaction or equivalent, a secure element (SE) adapted to store and execute the contactless application, and a NFC Front-end controller connected to host CPU/MCU and to the SE; and
the NFC devices being connected through the mobile Internet and the GPRS connection to a backend server to manage application download on the SE of the NFC devices and, when a new user subscribes a service, the contactless application is downloaded to the SE and the user interface is downloaded to the NFC device of the new user.
